(19) United States
(12) Patent Application Publication
(10) Pub. No.: US 2012/0120029 A1
(43) Pub. Date: May 17, 2012

(54) DISPLAY TO DETERMINE GESTURES

(76) Inventors: John P. McCarthy, Pleasanton, CA (US); John J. Briden, San Francisco, CA (US); Brandley neal Suggs, Sunnyvale, CA (US)

(21) Appl. No.: 13/386,433

(22) PCT Filed: Nov. 20, 2009
(86) PCT No.: PCT/US09/65395

§ 371 Date: Jan. 23, 2012

(30) Foreign Application Priority Data
Jul. 23, 2009 (US) PCT/US2009/051599

(51) Int. Cl. G06F 3/042

(52) U.S. Cl. 345/175

(57) ABSTRACT

A display system including a panel 110 with a surface 116 to display images. The system includes a three dimensional optical sensor 115. The three dimensional optical sensor can include a field of view 135 that includes a front surface of the display system 100 and a volume in front of the front surface of the display system. A controller 190 can receive information from the three dimensional optical sensor and can interpret the information from the three dimensional optical sensor as a gesture of an object 120 in the volume.

### BACKGROUND

A resistive touch screen panel is composed of two thin, metallic, electrically conductive layers separated by a narrow gap. When an object, such as a finger, presses down on a point on the panel's outer surface the two metallic layers become connected at that point and the panel then behaves as a pair of voltage dividers with connected outputs. This causes a change in the electrical current which is registered as a touch event and sent to the controller for processing. A capacitive touch screen panel is a sensor that is a capacitor in which plates include overlapping areas between the horizontal and vertical axes in a grid pattern. The human body also conducts electricity and a touch on the surface of the sensor will affect the electric field and create a measurable change in the capacitance of the device.

### BRIEF DESCRIPTION OF THE DRAWINGS

Some embodiments of the invention are described with respect to the following figures:

FIG. 1 is a display according to an example embodiment of the invention;

FIGS. 2a and 2b are a display according to an example embodiment of the invention;

FIG. 3 is a three dimensional optical sensor according to an example embodiment of the invention;

FIG. 4 is a display according to an example embodiment of the invention;

FIGS. 5A, 5B and 5C are a display according to an example embodiment of the invention;

FIG. 6 is a block diagram according to an example embodiment of the invention; and

FIG. 7 is a flow diagram according to an example embodiment of the method of the invention.

### DETAILED DESCRIPTION

A graphical user interface (GUI) can use a pointing device such as a mouse to move a cursor. The cursor can be controlled to perform functions. For example, functions that may be performed by moving the cursor are selecting a location, or moving an object on the screen. In other embodiments the cursor can perform other functions such as adjusting the size of the object displayed by selecting an edge of the object displayed and dragging the edge of the object displayed. The function that is performed by the computer depends on the programming of the interface and the application.

Touch screens can be used to move a cursor on a display or move on object on the display. A touch screen may recognize gestures when a user's hand or a stylus is in contact with the display. Displays may be two dimensional surfaces extending in an x and y direction but a user exists in three dimensions and can move in any direction not laying in the plane form by the two dimensional display surface.

In one embodiment a display includes a three dimensional optical sensor to determine the depth an object that is captured by the optical sensor is from the optical sensor. The distance the object is from the display can be calculated based upon the measured distance between the object and the optical sensor.

To manipulate objects on a non-touch screen the mouse may have to select the object and manipulate the object, by using menus. Gestures may be available to manipulate an object on the touch screen for example to zoom in on an object a user may spread their fingers. Gestures that are available on a touch screen may have a user touch the display and use their hands in an unnatural motion. A user may have to learn these unnatural motions through a training exercise and may forget gestures that are not used frequently. If a user could interact with the objects display on the display screen with natural motions in the volume in front of the display the user may be able to use natural movements to perform tasks. For example the user may simulate a natural motion to bring something closer to you when it is too small to view by grabbing on to an object displayed on the display and pulling the object displayed toward them to zoom on the object displayed.

In one embodiment, a display system includes a panel with a surface to display images. The display system also includes a three dimensional optical sensor. The three dimensional optical sensor can have a field of view that includes a front surface of the display system and an volume in front of the front surface of the display system. A controller can receive information from the three dimensional optical sensor and interpret the information from the three dimensional optical sensor as a gesture of an object in the volume.

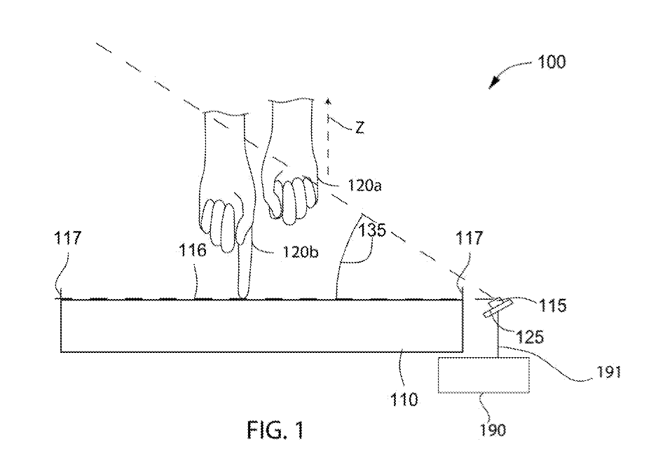

Referring to the figures, FIG. 1 is a display system 100 according to an example embodiment of the invention. The display system 100 includes a panel 110 including a surface 116 for displaying images. The front of the panel 110 is the surface 116 that displays an image and the back of the panel 110 is opposite the front. The panel 110 may be a liquid crystal display (LCD) panel, a plasma display, a cathode ray tube (CRT), an OLED or a projection display such as digital light processing (DLP), for example. In one embodiment, the three dimensional optical sensor may be attached in an area of the display system 100 that is outside of the perimeter 117 of the surface 116 of the panel 110.

The three dimensional optical sensor 115 can determine the depth from the three dimensional optical sensor of an object located in the field of view 135 of the three dimensional optical sensor 115. The field of view 135 of the three dimensional optical sensor 115 can determine the volume in front of the display system 100 where gestures can be recognized. In one embodiment the volume where gestures are recognized may be less than the volume that can be captured by the field of view 135 of the three dimensional optical sensor 115. The depth of the object can be used in one embodiment to determine if the object is within the contact distance from the surface 116 of the display system 100. The controller 190 may determine from the depth information that the object is contacting the display if the distance of the object from the display system is substantially zero centimeters. In one embodiment, substantially zero means that the resolution of the three dimensional optical sensor may not be able to determine contact with the display and an object that is less than a contact distance from the display system may have depth information from the three dimensional optical sensor that is determined by the controller 180 to be a distance of zero and a contact with the display system. A contact distance may be for example 0.2 centimeters from the display system but may be other distances. The depth of the object can be used in one embodiment to determine if the object is within the volume distance of the display but not within the contact distance of the display. For example the object 120 may be a user's hand and finger 120a, 120b approaching the transparent layer 105.

If the object 120a or 120b is within the field of view 135 of the three dimensional optical sensor 115, light from the light source 125 can reflect from the object and be viewed by the three dimensional optical sensor 115 to generate information. The information can be sent to a controller 190 through a connection 191. The information can include the location, for example the x, y, and z coordinates, of objects 120a and 120b in the volume, for example the hands of a user. In one embodiment the user can contact the display with an object 120b for example the user's finger to provide a selection of an object on the display that a user wants to manipulate. This allows the user to manipulate a specific object and not all objects or an unintentional object on the display. If, for example, the user then wants to zoom in on the object the user can make a first and move their first in the Z direction. When the object is zoomed to a desired distance the user can open their first to prevent further zooming of the object. The opening of the first may be similar to the user releasing their grip on a physical object for example and thus no longer moving the physical object when they move their hand.

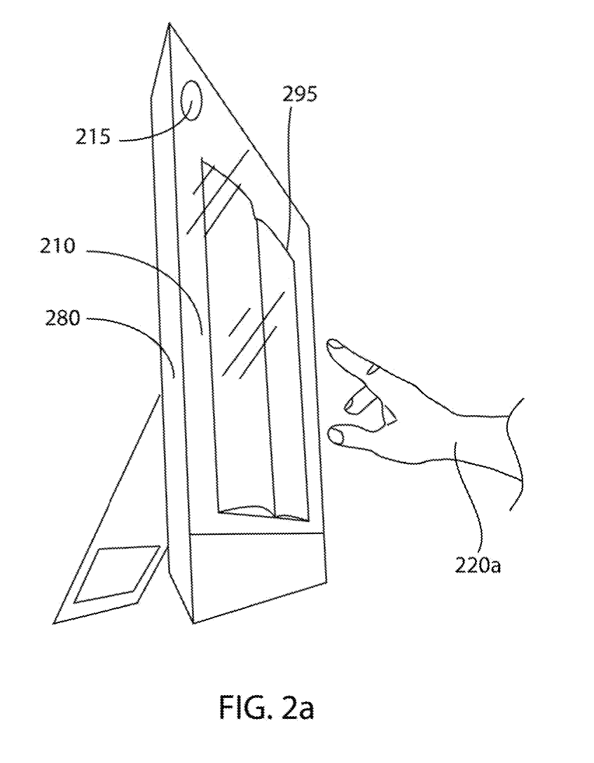

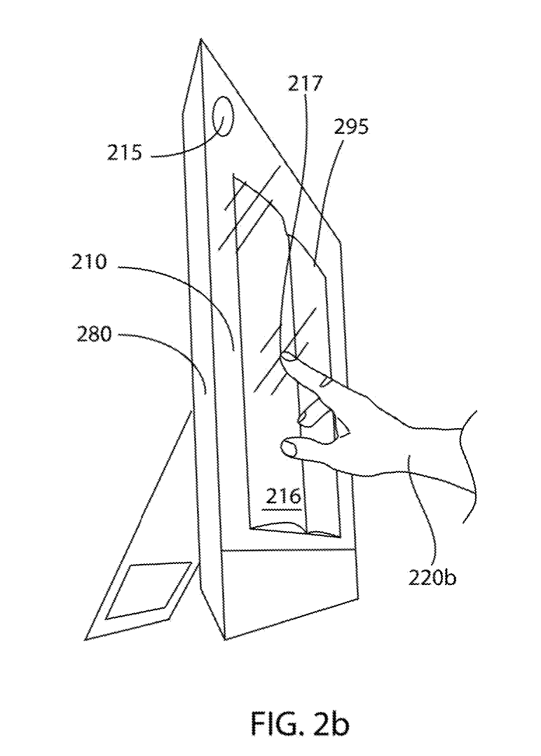

FIG. 2a is a display according to an example embodiment of the invention. The invention includes a display 210. A three dimensional optical sensor 215 is attached to the display 210. A computing system 280 can be connected to the display. The computing system 280 can be a desktop, portable computer, server computer, personal digital assistant, cell phone or other machine. In one embodiment the computing system is in the same chassis as the display is attached to. In another embodiment the computing system is separate from the display and the display can connect to the computing system. In one embodiment the three dimensional optical sensor can detect a gesture that is not in contact with the display. For example and object such as a user's hand can make a motion from right to left in the volume in front of the display 210 to flip the pages of a book 295 displayed on the display 210. The three dimensional optical sensor 215 can generate information that can be received by the computing system 280. A controller in the computing system 280 can determine from the different placements of an object such as the users hand 220a over a period of time what direction the user's hand is moving in. The controller can then determine if that movement is of the object is a gesture that is recognized by the computing system. A recognized gesture is a gesture that the computer system 280 is programmed with and performs a function on the computing system if the object 220a is determined to be performing that gesture. For example flipping a page in a book 295 may be a stored function in the computing system 280 that is performed if the controller determines that an object moves across the volume in front of the display in a right to left direction.

FIG. 2b is a display according to an example embodiment of the invention. The invention includes a display 210. If the three dimensional optical sensor 215 is attached to the display 210 the field of view of the three dimensional optical sensor can include the display surface 216. If the display surface is included in the field of view of the three dimensional optical sensor 215 then the three dimensional optical sensor 215 can also detect touches of the display surface 216. For example, an object 220b such as a user's hand can touch an area of the display 217 that is associated by the computer with a function. The function of the computer can be for example opening a link such as a link to additional information about a phrase in a book 295 that is displayed on the display 210.

The computing system 280 can receive the information from the three dimensional optical sensor 215 and a controller, for example the processor can determine from the information if the object 220b is contacting the display surface 216 and determine if the coordinates of the contact with the display surface 216 is an area of the display surface 216 that an image is being displayed on the display 210 that has a designated function assigned to the image.

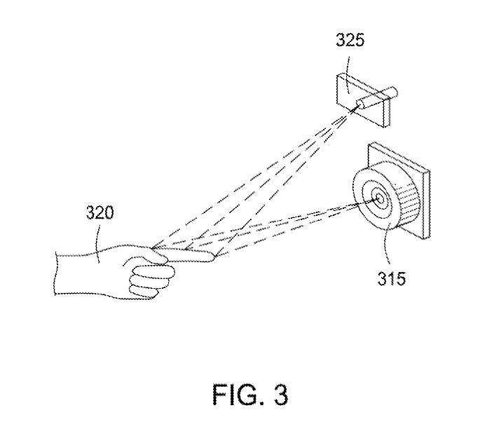

FIG. 3 is a three dimensional optical sensor 315 according to an example embodiment of the invention. The three dimensional optical sensor 315 can receive light from a source 325 reflected from an object 320. The light source 325 may be for example an infrared light or a laser light source that emits light that is invisible to the user. The light source 325 can be in any position relative to the three dimensional optical sensor 315 that allows the light to reflect off the object 320 and be captured by the three dimensional optical sensor 315. The infrared light can reflect from an object 320 that may be the user's hand, in one embodiment and is captured by the three dimensional optical sensor 315. An object in a three dimensional image is mapped to different planes giving a Z-order, order in distance, for each object. The Z-order can enable a computer program to distinguish the foreground objects from the background and can enable a computer program to determine the distance the object is from the display.

Two dimensional sensors that use a triangulation based methods such as stereo may involve intensive image processing to approximate the depth of objects. The two dimensional image processing uses data from a sensor and processes the data to generate data that is normally not available from a two dimensional sensor. Intensive image processing may not be used for a three dimensional sensor because the data from the three dimensional sensor includes depth data. For example, the image processing for a time of flight three dimensional optical sensor may involve a simple table-lookup to map the sensor reading to the distance of an object from the display. The time of flight sensor determines the depth from the sensor of an object from the time that it takes for light to travel from a known source, reflect from an object and return to the three dimensional optical sensor. The depth of an object in the image can be determined from the three dimensional optical sensor that does not use a second three dimensional optical sensor to determine the distance of the object in the image.

In an alternative embodiment the light source can emit structured light that is the projection of a light pattern such as a plane, grid, or more complex shape at a known angle onto an object. The way that the light pattern deforms when striking surfaces allows vision systems to calculate the depth and surface information of the objects in the scene. integral Imaging is a technique which provides a full parallax stereoscopic view. To record the information of an object, a micro lens array in conjunction with a high resolution optical sensor is used. Due to a different position of each micro lens with respect to the imaged object, multiple perspectives of the object can be imaged onto an optical sensor. The recorded image that contains elemental images from each micro lens can be electronically transferred and then reconstructed in image processing. In some embodiments the integral imaging lenses can have different focal lengths and the objects depth is determined based on if the object is in focus, a focus sensor, or out of focus, a defocus sensor. The embodiments of the invention are not limited to the type of three dimensional optical sensors that have been described but may be any type of three dimensional sensor.

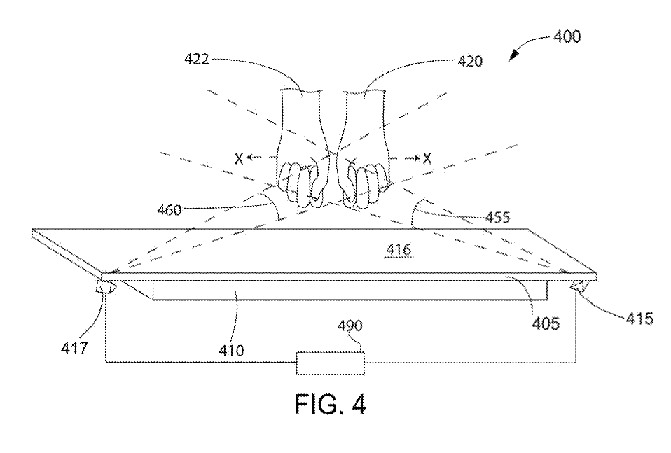

FIG. 4 is a display according to an example embodiment of the invention. In some GUIs a display system 400 that can sense more than one object 420 and 422 may be able to perform tasks within a program that would not be recognized by a single object. For example, a gesture such as simulating the grabbing of the edge of a document and moving the hands 420 and 422 apart in the x direction for example can be a gesture for deleting the document displayed on the display system 400 because the gesture simulates the motion that would be made if a document was torn in half.

In one embodiment, there is a first three dimensional optical sensor 415 and a second three dimensional optical sensor 417. The first three dimensional optical sensor 415 may have a field of view 455. The surface 416 may be the surface of the display system 400 that may include a transparent layer 405. The transparent layer 405 can be glass, plastic, or another transparent material. Within the field of view 455 an image of object 420 can be captured in one example. A second object 422 may not be seen by the first three dimensional optical sensor 415 because the first object 420 may be between the first three dimensional optical sensor 415 and the second object 422. The field of view 455 may be obstructed by the first object 420 along the portion of the field of view 455 beyond the first object 420 if viewed from the first three dimensional optical sensor 415. The second three dimensional optical sensor 417 can capture within its field of view 460 an image including the depth of the second object 422. The first three dimensional optical sensor 415 can determine the distance of a first object 420, for example a user's right hand. The first three dimensional optical sensor 415 may not be able to determine the distance of a second object 422, for example a user's left hand if the view by the first three dimensional optical sensor 415 of the second object 422 is obstructed by a the first object 420 but the second three dimensional optical sensor 417 may be able to determine the distance of the second object 422 from the second three dimensional optical sensor 417. The first three dimensional optical sensor 415 and the second three dimensional optical sensor 417 may be in the corners of the display system 400 or the optical sensors may be located anywhere in or on the display such as the top, bottom, or sides. The first and the second three dimensional optical sensors may be connected to a single controller 490 or multiple controllers to receive information from the three dimensional optical sensors.

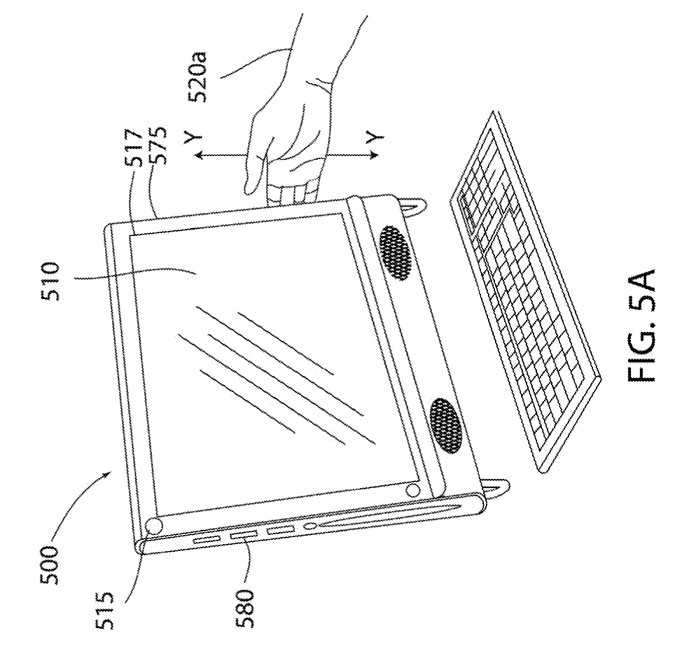

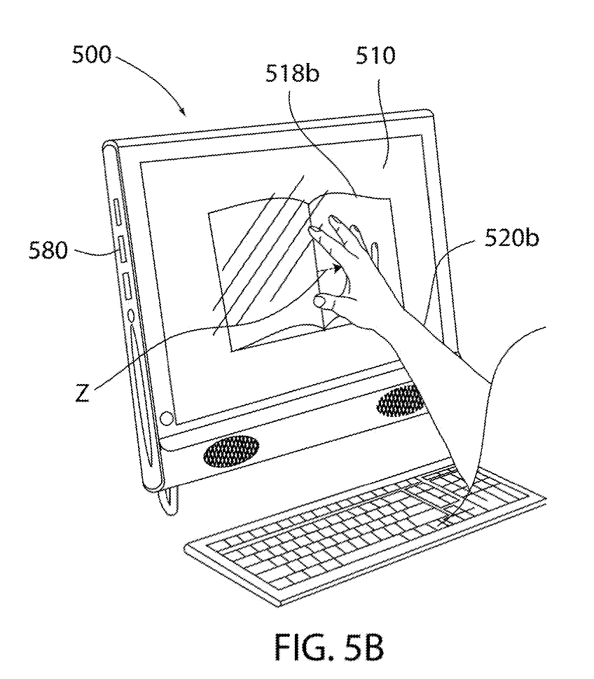

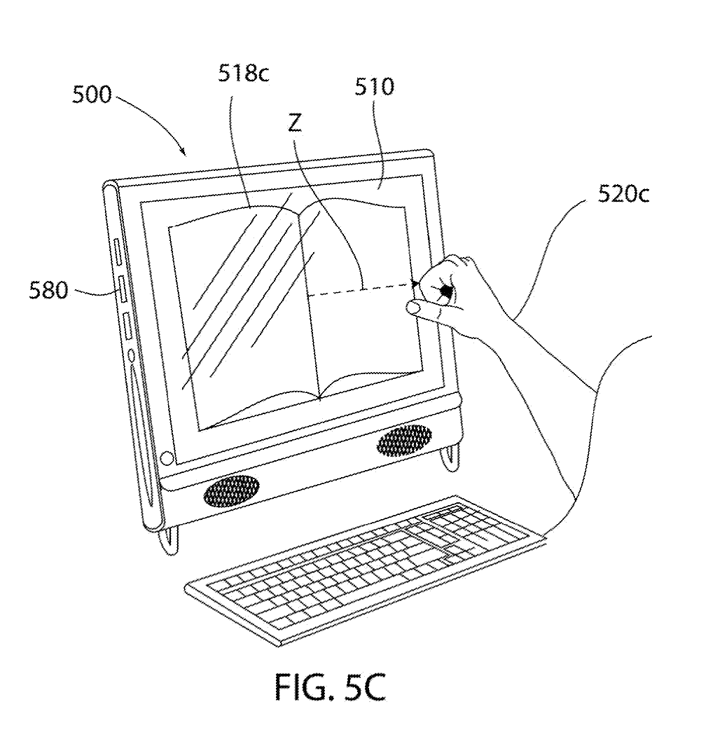

FIG. 5A is a display according to an example embodiment of the invention. The three dimensional optical sensor 515 has a viewable area that extends beyond the perimeter 517 of the display panel 510. The movement of objects beyond the perimeter 517 can activate functions of a computer system. For example a three dimensional optical sensor 515 may generate information that is sent to the computing system 580. The information can include information about the location of an object 520a, such as a user's hand. Over a period of time the information regarding the location of the object 520a can change. For example if the user's hand is at a first location at time A and 1 second later at time B the user's hand is at a second location the computer may determine the change in location as a movement in the Y direction. The movement can be a gesture that is programmed to perform a function on the computing system 580.

In one embodiment, a user may control functions such as volume by moving their hand in an upward or downward motion along the side 575 of the display system 500. The side of the display can be the area outside the perimeter of the panel 510. Examples of other functions that may be controlled by a user's hand along the side of the display panel are media controls such as fast forward and rewind and presentation controls such as moving to the next slide or a previous slide.

A user may program functions that the computer implements upon detecting certain movements. For example, a user may flip the page of the document on the display by moving their hand above the display from right to left to turn to the next page or left to right to turn to the previous page. In another example a user may move their hands in a motion that represents grabbing an object on the screen and rotating the object to rotate the object in a clockwise or counterclockwise direction. The user interface can allow the user to change the results of the hand motions that are detected by the three dimensional optical sensor. For example if the user moves their hand in front of the display in a right to left direction the computer can be programmed to interpret the motion as the flipping of a page or as closing a document.

FIG. 5B and FIG. 5C are a display system 500 according to an example embodiment of the invention. In one embodiment a user can approach the displayed object 518b on the display 510 with an open hand 520b. To control the displayed object 518b the user can close their hand. In FIG. 5C the user's hand is closed 520c and the movement of the user's hand can control the displayed object 518b. For example in FIG. 5C the user has moved their hand away from the display system 500 in the Z direction. This movement may zoom in on the displayed object 518b to create displayed object 518c. The computing system 580 can receive information from the three dimensional optical sensors and use that information to zoom in or out on the displayed object.

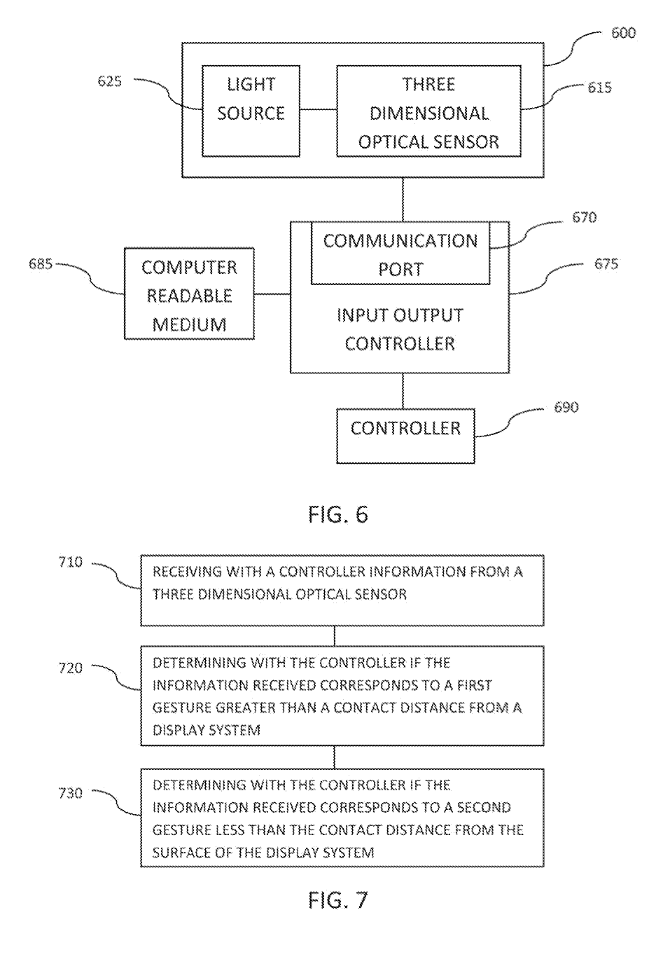

FIG. 6 is a block diagram according to an example embodiment of the invention. The optical sensor module 600 can include the light source 625 and the three dimensional optical sensor 615. The optical sensor module 600 can capture data that may include height, width, and depth of an object in an image. The optical sensor module 600 can connect to a communication port 670 to transmit captured information to a computing device. The communication port 670 can be a communication port 670 on a computing device. For example the communication port 670 can be a universal serial bus (USB) port or an IEEE 1394 port. The communication port 670 may be part of the input output controller 675 of the computing device, in one embodiment. The input output controller 675 can be connected to a computer readable medium 685. The input output controller 675 of a computing device can connect to a controller 690.

The controller 690 can receive data captured by the three dimensional optical sensor 615 through the communication port 670 of the input output controller 675. The controller 690 can determine from the data captured by the three dimensional optical sensor module 600 the distance an object is from the optical sensor module 600. The controller 690 can determine the distance the object is from a display based on the distance the object is from the three dimensional optical sensor module 600. In one embodiment, the controller 690 is a processor or an application specific integrated circuit (ASIC).

A computing system including the controller 690 can use the information to determine if a gesture has occurred. A gesture is a movement as a means of expression of for example the body, limbs, hand or fingers. The movement is determined by a change in location of the object, such a hand, as indicated by a change in the information generated by the three dimensional optical sensor 615 over a period of time.

FIG. 7 is a flow diagram according to an example embodiment of the method of the invention. The method begins by receiving at a controller information from a three dimensional optical sensor (at 710). The depth information includes the depth from the three dimensional optical sensor of objects in the field of view of the three dimensional optical sensor. For example, the three dimensional optical sensor may use time of flight, structured light, integral imaging or focus defocus to generate the depth information. The depth information can be received by a computing device. The computing device can be for example a computer system, a personal digital assistant or a cellular phone. The controller can determine if the information received corresponds to a first gesture greater than a contact distance from a display system (at 720). A contact distance may be for example 0.2 centimeters from the display system but may be other distances.

The controller can determine if the information received corresponds to a second gesture less than a contact distance from the surface of the display system (at 730). If the object comes in contact with the transparent layer the calculated distance that the object is from the display is zero. If the computer receives a signal that the distance is zero the computer can generate an activation of the icon if the computer determines that location of the object and the location of the image of the icon displayed on the panel correspond to each other. For example, the icon can represent a program that will be launched if the icon is activated.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A display system comprising:
a panel 110 with a surface 116 to display images;
a three dimensional optical sensor 115 including a field of view 135 that includes a front surface of the display system 100 and a volume in front of the front surface of the display system; and
a controller 190 to receive information from the three dimensional optical sensor and to determine if the information from the three dimensional optical sensor is a gesture of an object 120 in the volume.

2. The display system of claim 1, wherein a gesture is contacting the front surface 106 of the display system 100.

3. The display system of claim 2, wherein the information includes a first object in the volume and a second object contacting the front surface.

4. The display system of claim 1, further comprising a computer readable medium 685 to store gestures and associate the gestures with a computer function.

5. The display system of claim 2, wherein the controller accesses the computer readable medium 685 to determine the function.

6. The display system of claim 1, wherein the volume is between the front surface 106 and a volume distance.

7. The display system of claim 1, wherein the information from the three dimensional optical sensor 115 causes the controller 190 to zoom in on an image 518b on the display if the object moves toward the display system, then closes and moves away from the display system.

8. A method, comprising:
receiving at a controller 190 information from a three dimensional optical sensor 115;
determining with the controller 190 if the information received corresponds to a first gesture greater than the contact distance from a display system 100; and
determining with the controller if the information received corresponds to a second gesture less than a contact distance from the display system 100.

9. The method of claim 8, further comprising activating a first function of a computing system if it is determined that the first gesture corresponds to the first function.

10. The method of claim 8, further comprising activating a second function of a computing system if it is determined that the second gesture corresponds to the second function.

11. The method of claim 8, further comprising storing second information of different gestures in a computer readable medium 685.

12. The method of claim 11, further comprising comparing the information received from the three dimensional optical sensor and the second information in the computer readable medium.

13. The method of claim 12, further comprising zooming in on an image on the display if the information.

14. A computer readable medium comprising instructions that if executed cause a processor to:
receive information from a three dimensional optical sensor 115;
determine if the information received corresponds to a first gesture outside of the contact distance from a display system 100; and
determine if the information received corresponds to a second gesture less than a contact distance from the surface of the display system.

15. The computer readable medium of claim 14 further comprising instructions that if executed cause a processor to activate a first function of a computing system if it is determined that the first gesture corresponds to the first function.
